(19) United States
(12) Patent Application Publication
(10) Pub. No.: US 2017/0300293 A1
(43) Pub. Date: Oct. 19, 2017

(54) VOICE SYNTHESIZER FOR DIGITAL MAGAZINE PLAYBACK

(71) Applicant: Flipboard, Inc., Palo Alto, CA (US)

(72) Inventors: Howard H. Zhao, Palo Alto, CA (US); Luke James Scholefield, San Francisco, CA (US); Samuel Thompson, Houston, TX (US); Matthew Safian, San Francisco, CA (US)

(21) Appl. No.: 15/130,671

(22) Filed: Apr. 15, 2016

(51) Int. Cl. G06F 3/16; G06F 3/0482; G06F 17/28; G10L 13/06

(52) U.S. Cl. CPC G06F 3/167; G10L 13/06; G06F 3/0482; G06F 17/28

(57) ABSTRACT

A system converts a readable digital magazine into an audible digital magazine by generating an audio playlist of audio files corresponding to textual content items of the digital magazine. The system monitors a user's interactions with content items on a page of the digital magazine, where the content items include textual content items. Upon detecting a request from the user for audio files corresponding to the textual content items, the requested audio files are searched and retrieved. In response to not finding the requested audio files ready for playback, the textual content items are obtained and converted into the requested audio files. An audio playlist of the requested audio files is generated for presentation to the user of the digital magazine in response to the request.

### BACKGROUND

This disclosure relates generally to providing digital content to users of an online system, and more specifically to creating audio files of content items of a digital magazine for playing back the digital magazine.

Digital distribution channels disseminate to users a wide variety of digital content including videos, text, images, audio, links, and interactive media (e.g., games, collaborative content) from external or internal sources. A user of a digital magazine mobile application can read text articles, listen to audio files and watch video files that are displayed on the digital magazine. Some existing solutions only allow users to consume content items of a digital magazine in their original file formats, e.g., reading textual content items such as text articles, user-uploaded posts and comments, but not listening to the textual content items. Additionally, some of the existing solutions limit users of digital magazines in terms of concurrently navigating among different user applications running on the users' client devices. For example, while a user of a digital magazine can listen to some audio files of the digital magazine, the user cannot interact with other user applications, e.g., searching for content items using a web browser without interruption to the listening of the audio files of the digital magazine. Such limitations degrade user experience with digital magazines.

### SUMMARY

Embodiments of the disclosed invention generate an audio playlist of audio files corresponding to textual content items of a digital magazine for playing back the digital magazine. A user interacts with content items on pages of a digital magazine, such as reading a textual content item displayed on a page of the digital magazine. Upon detecting a request from the user for audio files of textual files (e.g., news articles) displayed on the digital magazine, e.g., clicking a “play” button displayed on the page, the textual files corresponding to the requested audio files are searched for in a digital magazine server, and are converted to audio files by a synthesizer of the digital magazine server, or by a synthesizer external to the digital magazine server, to generate an audio playlist for the requested audio files. The generated playlist is presented to the user in response to his/her request, allowing the user to play the audio playlist in a musical application (e.g., a media player). In one aspect, the user is able to listen to the audio files on the playlist within the digital magazine application, e.g., via the musical application running on the user's client device. In another approach, the user can listen to the audio files on the playlist via an external device (e.g., an external audio headset), while navigating away from the digital magazine application, e.g., interacting with other applications running on his/her client device.

### BRIEF DESCRIPTION OF THE FIGURES

FIG. 1 is a block diagram of a system environment for generating an audio playlist of audio files corresponding to content items of a digital magazine, according to one embodiment.

FIG. 2 is an example block diagram of a digital magazine server shown in FIG. 1, according to one embodiment.

FIG. 3 is an example digital magazine page displayed on the digital magazine, allowing a user to play back audio files corresponding to content items displayed on the page, according to one embodiment.

FIG. 4 shows interactions between the digital magazine server and a client device for generating an audio playlist of audio files corresponding to content items of a digital magazine, according to one embodiment.

FIG. 5 is a flowchart illustrating a process of generating an audio playlist of audio files corresponding to content items of a digital magazine, according to one embodiment.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

### DETAILED DESCRIPTION OF THE FIGURES

### Example Digital Magazine System Environment

One embodiment of a disclosed configuration is a system (or a computer implemented method or a non-transitory computer readable medium) for transforming a readable digital magazine into an audible one by converting textural content items of the digital magazine to an audio playlist of audio files corresponding to the textual content items. The audio playlist allows users of a digital magazine application executing on a client device of the user to listen to the audio files corresponding to textual content items of the digital magazine.

A “digital magazine” herein refers to an aggregation of digital content items that can be presented to users in a presentable format similar to the format used by print magazines. A “content item” herein refers to any machine-readable and machine-storable work product, such as textual articles, pictures/images, videos, user-generated content (e.g., content posted on a social networking system), advertisements, and any other types of digital content capable of display within the context of a digital magazine. In one embodiment, a digital magazine assembles a list of universal resource locators (URLs), where each video, image or textual article of the digital magazine is based on the content of a resource on the Internet to which a URL of the list of the URLs references to. An audio playlist herein refers to a list of audio files corresponding to content items of a digital magazine, which can be played in a sequential or a shuffled order.

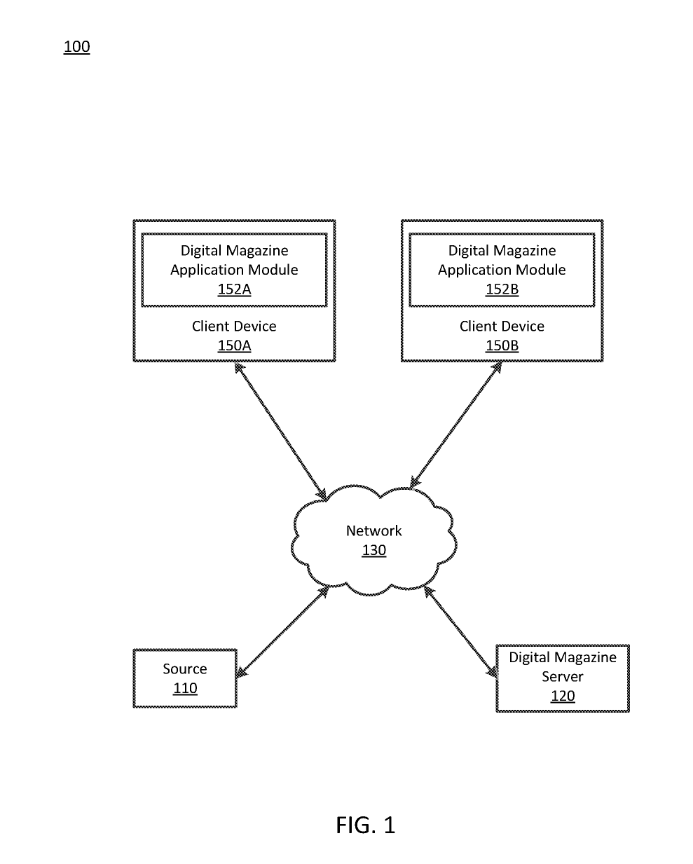

FIG. 1 is a block diagram of a system environment 100 for generating an audio playlist of audio files corresponding to content items of a digital magazine, according to one embodiment. The system environment 100 shown in FIG. 1 includes one or more client devices 150, a source 110, a digital magazine server 120 and a network 130. Only two client devices 150, one source 110 and one digital magazine server 120 are shown in FIG. 1 to simplify the description. Other embodiments of the system environment 100 can have multiple client devices 150, sources 110 and digital magazine servers 120 connected through the network 130. Additionally, the functions performed by various entities of FIG. 1 may differ in different embodiments. The embodiments described herein can be adapted to online systems that are not digital magazine servers 120.

A source 110 is a computing system capable of providing various types of digital content to a client device 150 and to a digital magazine server 120. Examples of content provided by a source 110 include text, images, video or audio on web pages, web feeds, social networking information, messages or other suitable digital data. Additional examples of content include user-generated content such as blogs, tweets, shared images, audios or videos, social networking posts and social networking status updates. Content provided by a source 110 may be received from a publisher and distributed by the source 110; alternatively, a source 110 may be the publisher that generates content. For convenience, content from a source 110, regardless of its composition, is referred to herein as a “content item”. A content item may include various types of content elements such as text, image, audio, video, interactive media, links and a combination thereof.

The digital magazine server 120 is a computer system that receives content items from one or more sources 110 or provided by users of the digital magazine server 120, generates pages in a digital magazine by processing the received content, and provides the pages to the client device 150 or provides instructions to the client device 150 to generate pages in a digital magazine. In one embodiment, in response to a request from a user of a digital magazine for audio files corresponding to textual content items of the digital magazine, the digital magazine server 120 determines whether the requested audio files are available for retrieval. If the requested audio files are ready for retrieval, the digital magazine server 120 retrieves the requested audio files, generates an audio playlist of the requested audio files, and presents the audio playlist to the user. If the requested audio files are not ready for retrieval, the digital magazine server 120 searches for textual files that correspond to the requested audio files and converts the textual files to the audio files. The digital magazine server 120 further generates an audio playlist of the audio files for presentation to the user. In another embodiment, the digital magazine server 120 provides instructions to the client device 150 to generate the audio playlist of audio files corresponding to textual content items of the digital magazine.

Transforming a readable digital magazine into an audible one by generating an audio playlist of audio files corresponding to textual content items of the digital magazine enables the user to play the audio playlist in a musical application (e.g., a media player) on the client device 150. The generated playlist further allows the user to listen to the textual files displayed on digital magazine, to control the playback of the digital magazine via an external device (e.g., an external headset), and to navigate away from the digital magazine application while listening to the audio files corresponding to the textual files. The transformation enhances user experience with the digital magazine.

The one or more sources 110, the digital magazine server 120 and the one or more client devices 150 communicate with each other via the network 130. The network 130 may comprise any combination of local area and/or wide area networks, using both wired and/or wireless communication systems. In one embodiment, the network 130 uses standard communications technologies and/or protocols. For example, the network 130 includes communication links using technologies such as Ethernet, 802.1, worldwide interoperability for microwave access (WiMAX), 3G, 4G, code division multiple access (CDMA), digital subscriber line (DSL), etc. Examples of networking protocols used for communicating via the network 130 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 130 may be represented using any suitable format, such as hypertext markup language (HTML) or extensible markup language (XML). In some embodiments, all or some of the communication links of the network 130 may be encrypted using any suitable technique or techniques.

The client device 150 is a computing device capable of receiving user input as well as transmitting and/or receiving digital data from the source 110 or the digital magazine server 120 via the network 130. Various embodiments of the client device 150 include a conventional computer system, such as a desktop or a laptop computer, and a device having computer functionality, such as a personal digital assistant (PDA), a mobile telephone, a smartphone or another suitable device. In one embodiment, the client device 150 executes a software application allowing a user of the client device 150 to interact with the digital magazine server 120. For example, a digital magazine application executing on the client device 150 communicates instructions or requests for content items to the digital magazine server 120. The client device 150 also executes a browser that receives pages from the digital magazine server 120 and presents the pages to a user accessing the client device 150. In another embodiment, the client device 150 interacts with the digital magazine server 120 through an API running on a native operating system of the client device 150, such as IOS® or ANDROID™.

Different client devices 150 may have different characteristics such as different processing capabilities, different connection speeds with the digital magazine server 120 over the network 130, and different device types (e.g., make, manufacture, and version). For example, in one embodiment, a client device 150 includes an audio speaker (not shown) to playback audio files, a display device (not shown) and an input device (not shown). A display device included in the client device 150 presents content items to a user of the client device 150. An input device included in the client device 150 receives input from a user of the client device 150. The user input is processed by the digital magazine application executing on the client device 150 to allow the user to interact with content items presented by the digital magazine server 120.

In FIG. 1, the client device 150 includes a digital magazine application module 152. Other embodiments of the client device 150 may include different or additional modules other than those shown in FIG. 1. The digital magazine application module 152 monitors the digital magazine application executing on the client device 150 according to instructions received from the digital magazine server 120. As one example, the digital magazine application module 152 executes the digital magazine application, allowing users to interact with the digital magazine. The digital magazine application module 152 may also launch a musical application (e.g., a media player) on the client device 150 to play the audio files on an audio playlist received from the digital magazine server 120, where the audio files correspond to textual content items of the digital magazine.

In one embodiment, the digital magazine application module 152 enables a user of the digital magazine to playback the audio files on the audio playlist within the context of the digital magazine. For example, the user of the digital magazine interacts with the audio files on the playlist through an interface displayed on pages of the digital magazine, such as play, pause, and stop the playing back of the audio files. In another embodiment, the digital magazine application module 152 allows users to control the audio files via an external headset instead of interacting with the interface of digital magazine. Controlling the playback of the audio files on the playlist via the external headset allows the user to interact with other applications running on the client device 150 while listening to the audio files being played by the playlist.

### Example Digital Magazine Server

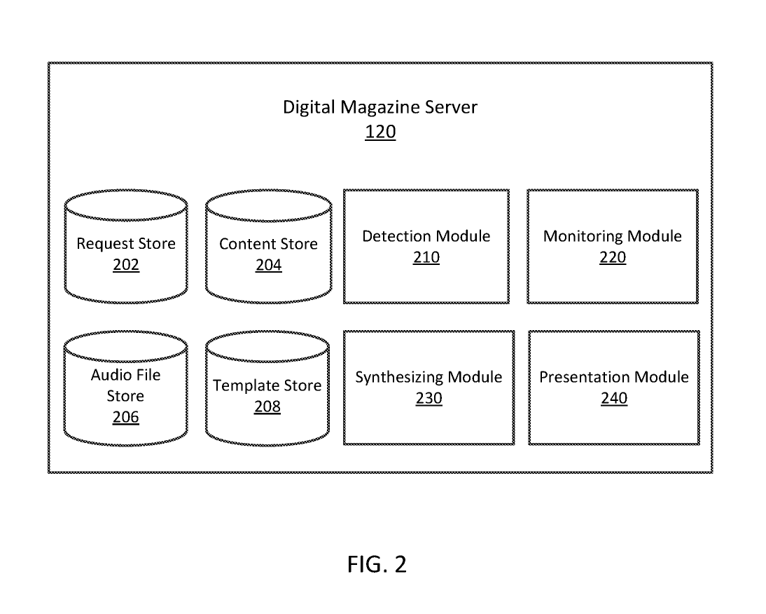

FIG. 2 is an example block diagram of a digital magazine server 120 shown in FIG. 1, according to one embodiment. The digital magazine server 120 shown in FIG. 2 includes a request store 202, a content store 204, an audio file store 206, a template store 208, a detection module 210, a monitoring module 220, a synthesizing module 230 and a presentation module 240. In alternative embodiments, the digital magazine server 120 may include additional, fewer, or different entities for various applications. Likewise, the functions performed by various entities of the digital magazine server 120 shown in FIG. 2 may differ in different embodiments.

The request store 202 stores requests from users of digital magazines for audio files corresponding to textual content items of the digital magazines running on the client devices 150. The requests from a user of a digital magazine may be received by the digital magazine server 120 via an interface of the digital magazine and stored in the request store 202. A request received from a user may be a request for audio files of textual files displayed on the digital magazine, for example, textual articles, user-uploaded posts or comments that are displayed on the digital magazine.

The content store 204 stores objects that represent various types of digital content items. In one embodiment, the objects are URLs, each of which references to a resource on the Internet. The content store 204 may also store content items referenced by the URLs. Examples of content items stored in the content store 204 include textual articles, page posts, status updates, images (e.g., photographs), video links, audios, check-in events at locations, or any other types of content. The content store 204 may store links (e.g., URLs) and/or referenced content items within a threshold time of a current time (e.g., 6 months). As one example, the content store 204 stores URLs that reference specific textual files and referenced textual files received from one or more sources 110. As another example, the content store 204 also stores user-uploaded files that are created by users. The synthesizing module 230 retrieves the links and/or textual files stored in the content store 204 to generate corresponding audio files in response to user requests stored in the request store 202.

The audio file store 206 stores audio files corresponding to textual content items of digital magazines that are requested by users of the digital magazines, and that are converted from corresponding textual content items. In one embodiment, the audio file store 206 may store only the links (e.g., URLs) for the converted audio files, which are stored in a storage, e.g., a computer server in a cloud network. Storing the converted audio files outside the digital magazine server 120 saves storage space of the digital magazine server 120. In another embodiment, the audio file store 206 may store both links (URLs) and corresponding audio files. The audio file store 206 may also store a plurality of audio playlists generated by the synthesizing module 230, as described below, each of which is a list of converted audio files that are requested by a user. In one embodiment, each audio playlist has an identification, e.g., a list number, which is associated with a digital magazine presented to the user of the digital magazine. The stored playlists are used by the presentation module 240 for presenting to users that request the audio files.

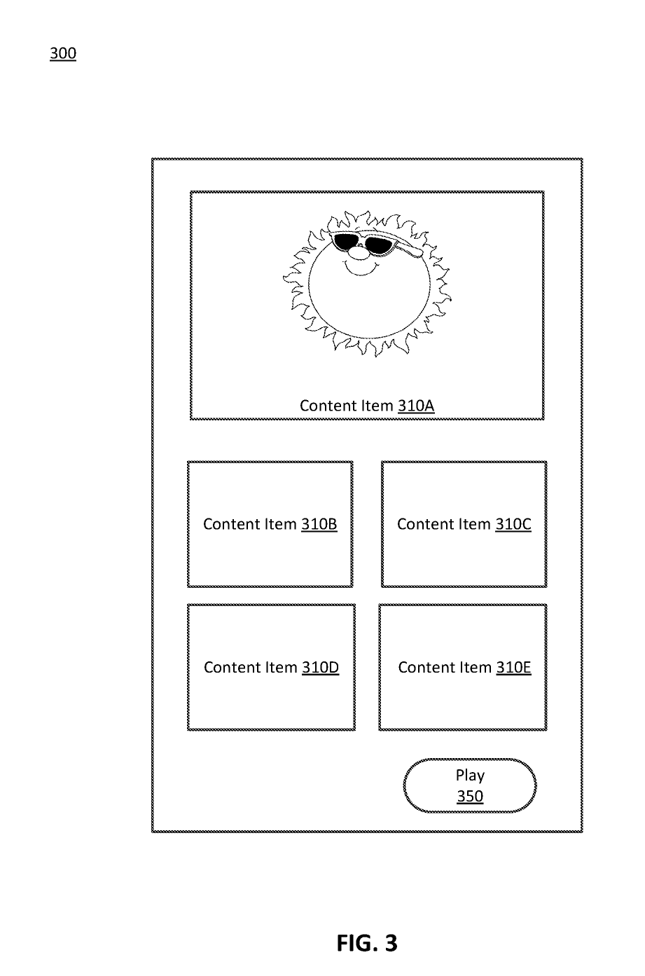

The template store 208 stores page templates, each describing a spatial arrangement (“layout”) of content items relative to each other on a page for presentation by a client device 150. One or more page templates may be associated with types of client devices 150, allowing content items to be presented in different relative locations and with different sizes when the content items are viewed using different client devices 150. Additionally, page templates may be associated with sources 110, allowing a source 110 to specify the format of pages presenting content items received from the source 110. In one embodiment, the template store 208 also stores layout for the “Play” button, as described below in FIG. 3, for playing back the generated audio playlist on a client device 150.

The detection module 210 detects a request from a user of a digital magazine for audio files corresponding to textural content items displayed on the digital magazine and stores the requests in the request store 202. In one embodiment, the detection module 210 detects a user request for audio files of corresponding textural content items displayed on a digital magazine in response to the user clicks a “Play” button displayed on the digital magazine (e.g., the play button 350 shown in FIG. 3). In another embodiment, the detection module 210 detects a user request for audio files of corresponding textural content items in response to the user clicking any textual content item. For example, in response to the user clicking a textual content item on the digital magazine, the detection module 210 presents the user a graphical user interface (GUI) with an option to playback the textual content items of the digital magazine.

The monitoring module 220 receives requests for audio files of corresponding textual files displayed on the digital magazine from the detection module 210. The monitoring module 220 searches for the requested audio files in the audio file store 206. Responsive to finding the requested audio files in the audio file store 206, the monitoring module 220 retrieves the audio files and sends the audio files to the synthesizing module 230 to generate an audio playlist. On the other hand, responsive to not finding the requested audio files in the audio file store 206, the monitoring module 220 searches for the textual files corresponding to the requested audio files in the content store 204 or on the Internet and sends the textual files to the synthesizing module 230 to generate corresponding audio files and an audio playlist of the generated audio files.

The synthesizing module 230 generates an audio playlist of audio files corresponding to textual content items displayed on a digital magazine. In one embodiment, the synthesizing module 230 receives the audio files retrieved by the monitoring module 220 and generates an audio playlist for the audio files. The audio playlist includes one or more indices, each of which is associated with an audio file corresponding to a textual content item of the digital magazine. The synthesizing module 230 provides the audio playlist to the presentation module 240 for playing back the audio files by the user of the digital magazine.

In response to no audio files corresponding to the textual content items requested by the user of the digital magazine that are ready for playback, the synthesizing module 230 converts the textual content items to audio files. In one embodiment, the synthesizing module 230 executes a computer program, e.g., a speech synthesizer, within the digital magazine server 120 to convert the textual content items to audio files. In another embodiment, the synthesizing module 230 may use a speech synthesizer on the client device 150 to convert the textual content items to audio files. In one embodiment, the speech synthesizer converts written text to a phonemic representation, and converts the phonemic representation to waveforms that can be output as sound. Any text-to-speech conversion schemes known to those of ordinary skills in the art, e.g., Festive Speech Synthesis System, can be used by the synthesizing module 230.

The synthesizing module 230 also provides support for multi-language text-to-speech conversion, e.g., converting textual content items written in English to corresponding audio files in Chinese. The audio playlist can also have an accent-choice support, which allows a user to choose among different accents that read articles to the user. As another example, the playlist may enable a user to save an article he/she is listening to for offline use, which allows the user to replay the audio files of specific textual files when the digital magazine application is not running on the client device 150.

As described above, the converted audio files are stored in the audio file store 206. When a user requests an audio file that has been converted and stored in the audio file store 206, for example, generated in response to a request by a different user prior to the current request, the synthesizing module 230 reuses the audio file by retrieving the audio files from the audio file store 206. The synthesizing module 230 also generates an audio playlist for the audio files synthesized from the corresponding textual content items, and stores the generated playlist in the audio file store 206.

The presentation module 240 receives or retrieves an audio playlist of audio files and presents the audio playlist to the client device 150 as a response to the user request. In one embodiment, the presentation module 240 instructs the digital magazine application on the client device 150 to present content items in specific layouts on a page of the digital magazine. In one embodiment, the presentation module 240 includes a “Play” button for the user of the digital magazine to play the generated audio playlist.

### Example Presenting Page of a Digital Magazine

FIG. 3 is an example digital magazine page displayed on the digital magazine, allowing a user to play back the audio files corresponding to content items displayed on the page, according to one embodiment. The digital magazine page 300 shown in FIG. 3 includes multiple content items 310A-310E and a play button 350. The content items 310 on the digital magazine page 300 can have various types and/or content. As one example, the content item 310A is an image item showing a cartoon sun, and the content items 310B-310E are textual content items, such as textual articles, comments or posts. Only five content items 310 are shown in FIG. 1 to simplify the description. In alternative embodiments not shown, the digital magazine page 300 may have additional, fewer or different entities. Likewise, the content items displayed on the digital magazine page 300 may have various types, such as audios, video links, audios, check-in events at locations, tweets, blogs, etc.

The play button 350 is a button displayed on the digital magazine page 300 for a user to click. In one embodiment, when a user clicks the play button 350, the user is capable of listening to a playlist that plays audio files of the textual items 310B-310E (e.g., a textual article) displayed on the page 300 via a musical application (e.g., a media player) launched by the digital magazine. In alternative embodiments not shown, the audio files may also include audio files converted from textual content items on different pages of the digital magazine. For example, one news article may have multiple parts that are displayed on multiple pages of the digital magazine including the page 300, and the user can listen to the audio file for the complete news article in response to the user clicking the play button 350.

In one embodiment, listening to the audio files on the playlist does not prevent the user from interacting with other content items of the digital magazine or from navigating away from the digital magazine. In one embodiment, the user listens to the audio files via a media player associated with the digital magazine, where a media player interface (not shown in FIG. 3) of the media player allows the user to play with a variety of functions of the playlist, for example, to pause, stop, replay, fast forward, rewind or play the playlist in a sequential or shuffled order or in a user-defined order. For example, the user can skip a currently playing audio file corresponding to one article and switch to listen to a different article of the digital magazine. Taking FIG. 3 as another example, the user can interact with the image content item 310A while listening to audio files corresponding to the textual content items 310B-310E.

In another embodiment, the user can access and control the playlist via an external headset while listening to the audio files of the playlist. For example, the user can control the playback of the audio files of the playlist via using the external headset, while engaging in other software applications running on the client device 150 such as browsing the web.

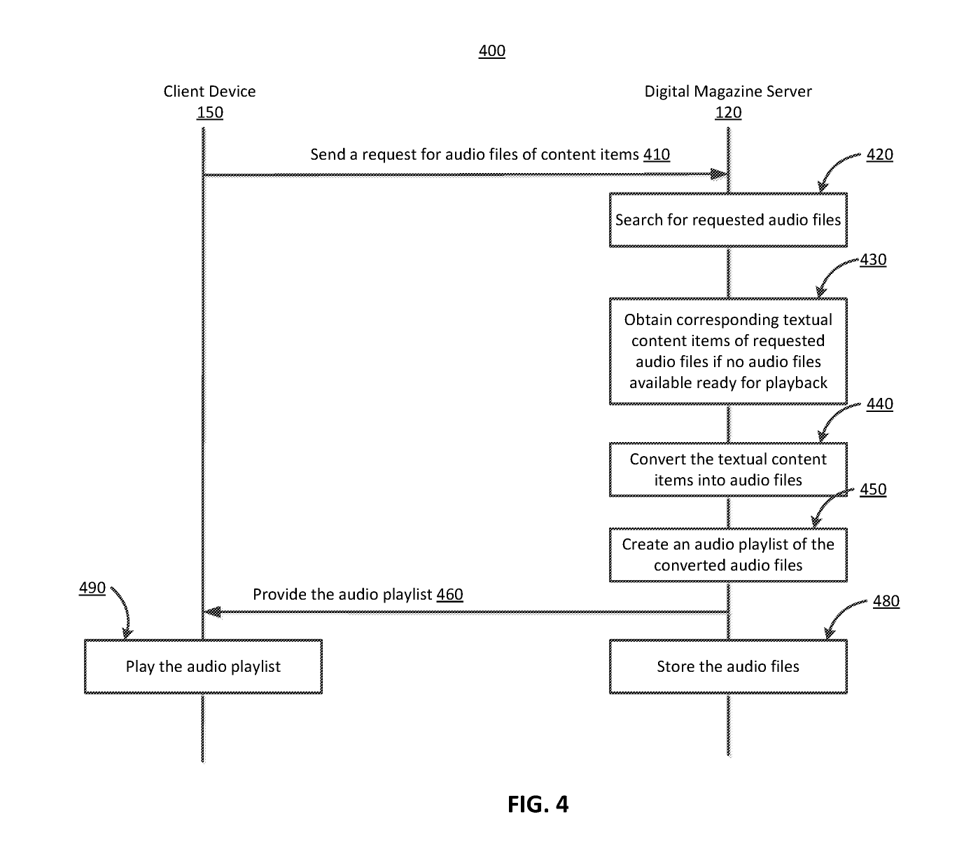

FIG. 4 shows interactions between the digital magazine server 120 and a client device 150 for generating an audio playlist of audio files corresponding to content items of a digital magazine, according to one embodiment. Only one client device 150 is illustrated in FIG. 4 to simplify the description. In alternative embodiments not shown, the interactions 400 may happen between the digital magazine server 120 and many client devices 150 at the same time or at different times. Likewise, additional or different entities may be included in the communications 400 and the functions performed by the entities may vary.

Initially, the client device 150 sends 410 a request for audio files of textual content items of a digital magazine to the digital magazine server 120. In response to the digital magazine server 120 receiving the request from the client device 150, the digital magazine server searches for 420 the requested audio files within the digital magazine server or in the cloud.

In one embodiment, if the digital magazine server 120 does not find the requested audio files corresponding to the textual content items displayed on the digital magazine, the digital magazine server 120 obtains 430 the corresponding textual content items of the requested audio files and converts 440 the textual content items to audio files. After the audio files are generated, the digital magazine server 120 creates 450 a playlist for the generated audio files.

In another embodiment, if the digital magazine server 120 finds the requested audio files available for use, for example, from the audio file store 206 of the digital magazine server or on the Internet, the digital magazine server obtains the audio files directly instead of converting from corresponding textual content items and creates 450 the playlist of the audio files.

The digital magazine server 120 provides 460 the created playlist to the client device 150 for presentation on the client device. The client device 150 may play 490 the audio playlist via a musical application (e.g., a media player) on the client device 150. The digital magazine server 120 also stores 480 the generated audio files in the digital magazine server or on the Internet for future use or archiving purpose. For example, when a request for the same audio files from a different user is received, the digital magazine server 120 retrieves the audio files directly from the storage place storing the audio files.

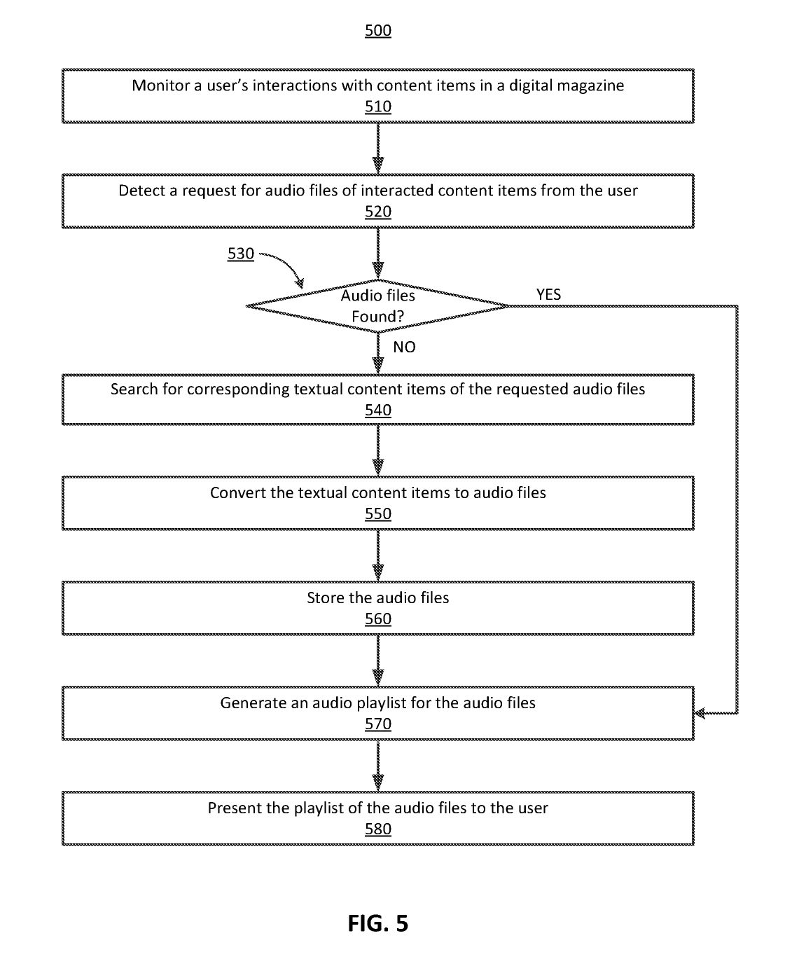

FIG. 5 is a flowchart illustrating a process of generating an audio playlist of audio files corresponding to content items of a digital magazine, according to one embodiment. Initially, the digital magazine server 120 monitors 510 user interactions from a user with content items displayed in a digital magazine. In response to detecting 520 a request for audio files of interacted textual content items (e.g., textual articles) from the user, the digital magazine server 120 determines 530 whether the requested audio files are available. If the requested audio files are available, the digital magazine server 120 generates 570 an audio playlist for the audio files and presents 580 the audio playlist to the client device of the user.

If the requested audio files are not available for use, the digital magazine server 120 searches for 540 the corresponding textual content items of the requested audio files for synthesizing. In one embodiment, the digital magazine server 120 converts 550 the obtained textual content items to corresponding audio files. The digital magazine server 120 stores 560 the converted audio files and generates 570 an audio playlist for the audio files. The generated playlist including the requested audio files is provided 580 to the client device of the user for playing back the digital magazine.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

The above description is included to illustrate the operation of the preferred embodiments and is not meant to limit the scope of the invention. The scope of the invention is to be limited only by the following claims. From the above discussion, many variations will be apparent to one skilled in the relevant art that would yet be encompassed by the spirit and scope of the invention.

What is claimed is:

1. A computer-implemented method, comprising:
monitoring a user's interactions with content items presented in a digital magazine on a client device, the content items including a plurality of textual content items;
detecting a request from the user for audio files corresponding to the plurality of textual content items of the digital magazine;
converting the plurality of textual content items to a plurality of corresponding audio files;
generating an audio playlist comprising a plurality of indices of the converted audio files; and
presenting the audio playlist to the user to play back the plurality of the textual content items of the digital magazine.

2. The method of claim 1, wherein detecting a request from the user for audio files corresponding to the plurality of textual content items of the digital magazine comprises:
detecting a request from the user via an interface of the digital magazine on the client device.

3. The method of claim 1, wherein converting the plurality of textual content items to a plurality of corresponding audio files comprises:
converting the plurality of textual content items to a plurality of corresponding audio files via a speech synthesizer; and
storing the converted plurality of audio files in a storage place.

4. The method of claim 1, further comprising:
determining whether the requested audio files are available for generating the audio playlist.

5. The method of claim 4, further comprising:
in response to determining the requested audio files are not available for generating the audio playlist:
searching for the plurality of textual content items corresponding to the requested audio files; and
retrieving the textual content items corresponding to the requested audio files.

6. The method of claim 4, further comprising:
in response to determining the requested audio files are available for generating the audio playlist:
retrieving the requested audio files for generating the audio playlist.

7. The method of claim 3, wherein converting the plurality of textual content items to a plurality of corresponding audio files via a speech synthesizer comprises:
converting the textual content items to a phonemic representation;
converting the phonemic representation to waveforms; and
outputting the waveforms as sound of audio files.

8. The method of claim 1, wherein converting the plurality of textual content items to a plurality of corresponding audio files further comprises:
providing a multi-language support to the audio files, the multi-language support allowing the user to choose different languages of the audio files.

9. The method of claim 1, wherein presenting the audio playlist to the user to play back the plurality of the textual content items of the digital magazine further comprises:
playing back the audio files via a musical application associated with the digital magazine.

10. The method of claim 1, wherein presenting the audio playlist to the user to play back the plurality of the textual content items of the digital magazine further comprises:
playing back the audio files via an external device of the digital magazine such that the user can navigate away from the digital magazine while the audio files are being played back via the external device.

11. A non-transitory computer-readable storage medium storing computer program instructions, the computer program instructions when executed by a computer processor causes the processor to perform steps of:
monitoring a user's interactions with content items presented in a digital magazine on a client device, the content items including a plurality of textual content items;
detecting a request from the user for audio files corresponding to the plurality of textual content items of the digital magazine;
converting the plurality of textual content items to a plurality of corresponding audio files;
generating an audio playlist comprising a plurality of indices of the converted audio files; and
presenting the audio playlist to the user to play back the plurality of the textual content items of the digital magazine.

12. The non-transitory computer-readable storage medium of claim 11, wherein detecting a request from the user for audio files corresponding to the plurality of textual content items of the digital magazine comprises:
detecting a request from the user via an interface of the digital magazine on the client device.

13. The non-transitory computer-readable storage medium of claim 11, wherein converting the plurality of textual content items to a plurality of corresponding audio files comprises:
converting the plurality of textual content items to a plurality of corresponding audio files via a speech synthesizer; and
storing the converted plurality of audio files in a storage place.

14. The non-transitory computer-readable storage medium of claim 11, further comprising:
determining whether the requested audio files are available for generating the audio playlist.

15. The non-transitory computer-readable storage medium of claim 14, further comprising:
in response to determining the requested audio files are not available for generating the audio playlist:
searching for the plurality of textual content items corresponding to the requested audio files; and
retrieving the textual content items corresponding to the requested audio files.

16. The non-transitory computer-readable storage medium of claim 14, further comprising:
in response to determining the requested audio files are available for generating the audio playlist:
retrieving the requested audio files for generating the audio playlist.

17. The non-transitory computer-readable storage medium of claim 13, wherein converting the plurality of textual content items to a plurality of corresponding audio files via a speech synthesizer comprises:
converting the textual content items to a phonemic representation;
converting the phonemic representation to waveforms; and
outputting the waveforms as sound of audio files.

18. The non-transitory computer-readable storage medium of claim 11, wherein converting the plurality of textual content items to a plurality of corresponding audio files further comprises:
providing a multi-language support to the audio files, the multi-language support allowing the user to choose different languages of the audio files.

19. The non-transitory computer-readable storage medium of claim 11, wherein presenting the audio playlist to the user to play back the plurality of the textual content items of the digital magazine further comprises:
playing back the audio files via a musical application associated with the digital magazine.

20. The non-transitory computer-readable storage medium of claim 11, wherein presenting the audio playlist to the user to play back the plurality of the textual content items of the digital magazine further comprises:
playing back the audio files via an external device of the digital magazine such that the user can navigate away from the digital magazine while the audio files are being played back via the external device.
